(19) United States
(12) Patent Application Publication
(10) Pub. No.: US 2026/0229442 A1
(43) Pub. Date: Aug. 6, 2026

(54) ELECTRON TUBE

(71) Applicant: Nisshinbo Micro Devices Inc., Tokyo (JP)

(72) Inventors: Hideyuki OBATA, Fujimino-shi, Saitama (JP); Kaoru MIYAZAKI, Fujimino-shi, Saitama (JP); Hiroyuki UMEHARA, Fujimino-shi, Saitama (JP)

(73) Assignee: Nisshinbo Micro Devices Inc., Tokyo (JP)

(21) Appl. No.: 19/142,798

(22) PCT Filed: Dec. 28, 2022
(86) PCT No.: PCT/JP2022/048520

§ 371 Date: Jun. 24, 2025

(51) Int. Cl. H01J 29/89; H01J 29/02; H01J 29/06

(52) U.S. Cl. CPC H01J 29/89; H01J 29/023; H01J 29/06

(57) ABSTRACT

An electron tube is provided including: a cathode that emits thermoelectrons; an anode including a plurality of anode pieces arranged, so as to surround the cathode, in an anode cylinder inside an anode cylindrical structure, in which a cavity resonator is formed; an input portion at which a cathode lead applying an input voltage is arranged; an output portion that emits microwaves outside; and a waveguide (W1) that transmits microwaves, in which a sealable shield casing that surrounds a part of the cathode lead is joined onto the outside surface of the anode cylindrical structure on the input portion side; the waveguide (W1) that is sealable is joined onto the outside surface of the anode cylindrical structure on the output portion side; and the anode cylindrical structure has a communication hole having a first opening that opens to an area surrounded by the shield casing and a second opening that opens to the interior of the waveguide (W1).

### TECHNICAL FIELD

The present invention relates to an electron tube, and in particular, relates to an electron tube that outputs high power microwaves.

### BACKGROUND ART

In order to realize a higher power output of Linac (linear accelerator) systems and the like for medical or non-destructive testing purposes, it is necessary to improve an insulation withstand voltage of an electron tube that is a microwave oscillation source and a transmission path that transmits microwaves outputted from the electron tube. For example, it is necessary to improve a withstand voltage of an input portion to which a high input voltage is applied in a magnetron that is a microwave oscillation source, and is necessary to improve a power capacity (a high frequency withstand voltage against an occurrence of tube arcing) in a waveguide that transmits microwaves that is outputted from the magnetron.

In order to improve a withstand voltage of an input portion of a magnetron, for example, Patent Document 1 discloses a structure in which a rod-shaped conductor (corresponding to a cathode lead) to which a high voltage is applied is covered by an insulator such as silicon rubber. Further, in order to improve a power capacity of a waveguide that transmits microwaves, for example, Patent Document 2 discloses a technique in which an atmosphere of sulfur hexafluoride (SF₆) gas and the like or a high vacuum is maintained inside a waveguide.

### PRIOR ART DOCUMENT

### Patent Document

Patent Document 1: JP H5-74356 A

Patent Document 2: JP 2006-245978 A

### SUMMARY OF THE INVENTION

### Problem to be Solved by the Invention

By enhancing an insulation between terminals to which a voltage is applied by covering an input portion of a magnetron by an insulator as described above, it becomes possible to enhance an input voltage to approximately 20 kV. As a result, it becomes possible to enhance an output electric power of an electron tube to approximately 80 kW.

However, along with a request for a higher power output directed to an electron tube, there has been a demand for enhancing an output electric power of a magnetron to 3 MW or more, as an example. In this case, it is necessary to set an input voltage of the magnetron to be approximately 46 kV, for example. Such high-power microwaves can be transmitted by filling a waveguide with a pressurized dry air or a sulfur hexafluoride gas having a high insulation performance or by maintaining a vacuum state inside the waveguide. However, due to heat conduction or radiation from a cathode, an anode that has a high temperature during operation, and the like, such a high-power magnetron cannot adopt a structure covering those with an insulator such as silicon rubber. Accordingly, it is necessary to improve a withstand voltage of an input portion of a magnetron by means of another insulation structure.

In order to improve a withstand voltage of an input portion of a magnetron, for example, it can be considered to adopt a structure in which an input portion is covered by a sealable casing and the casing is filled with an insulation oil or a gas having a high insulation performance. However, since the input portion has a high temperature and thus the insulation oil or gas may possibly be leaked from the casing because of thermal expansion, a complex structure that absorbs a pressure caused by the expansion is needed to prevent the leakage. Moreover, in a structure in which a gas is filled inside the casing, an inlet for injecting the gas is needed and further a complex structure that maintains a pressurized condition after the gas injection and detects that the pressurized condition is maintained, and from these aspects as well, it is difficult to adopt such a structure.

Therefore, it is an object of the present invention to provide an electron tube that allows a higher power output by improving a withstand voltage of an input portion without making its structure complex.

### Means to Solve the Problem

One embodiment of an electron tube of the present invention includes: a cathode that emits thermoelectrons; an anode including a plurality of anode pieces arranged, so as to surround the cathode, in an anode cylinder inside an anode cylindrical structure, in which a cavity resonator is formed between the anode pieces; an input portion from which a cathode lead to apply an input voltage to the cathode is drawn out; an output portion that emits microwaves excited in the cavity resonator outside; and a waveguide that transmits microwaves emitted from the output portion, and the electron tube is configured such that a sealable shield casing that surrounds a part of the cathode lead is joined onto the outside surface of the anode cylindrical structure on the input portion side, wherein the waveguide that is sealable is joined onto the outside surface of the anode cylindrical structure on the output portion side, and wherein the anode cylindrical structure has a communication hole including a first opening that opens to an area surrounded by the shield casing and a second opening that opens to an interior of the waveguide.

### Effects of the Invention

According to the electron tube of the present invention, the interior of a waveguide that transmits high-power microwaves and the interior of a shield casing are communicated with each other, and a withstand voltage of an input portion is improved, so that a high-power electron tube can be provided, since the electron tube is configured to have a communication hole having openings respectively in an area that is surrounded by the shield casing covering a part of a cathode lead for applying an input voltage to a cathode and in the waveguide that transmits microwaves emitted from an output portion.

### BRIEF DESCRIPTION OF THE DRAWINGS

FIG. 1 is a schematic cross-sectional view of an electron tube according to an embodiment (Embodiment 1) of the present invention.

FIG. 2 is a schematic cross-sectional view of an electron tube according to another embodiment (Embodiment 2) of the present invention.

FIG. 3 is a schematic cross-sectional view of an electron tube according to yet another embodiment (Embodiment 3) of the present invention.

FIG. 4 is a schematic cross-sectional view of an electron tube according to yet another embodiment (Embodiment 4) of the present invention.

FIG. 5 is a schematic cross-sectional view of an electron tube according to yet another embodiment (Embodiment 5) of the present invention.

FIG. 6 is a partially enlarged view of a joint portion between a third hole portion and a second hole portion that constitute a communication hole in Embodiment 5.

FIG. 7 is a schematic cross-sectional view of an electron tube according to yet another embodiment (Embodiment 6) of the present invention.

FIG. 8 is a partially enlarged view of a joint portion between a fourth hole portion and a second hole portion that constitute the communication hole in Embodiment 6.

### EMBODIMENT FOR CARRYING OUT THE INVENTION

An electron tube of the present invention is explained with reference to the drawings, but the present invention is not limited to these embodiments, and members and the like described below can be variously modified within the scope of the spirit of the present invention. Further, the same reference sign in the drawings indicates an equivalent or the same component, and relationships in terms of size, position, and the like between components are merely for the purpose of convenience and do not strictly reflect their actual states.

In the electron tube of the present invention, a sealable shield casing that surrounds a part of a cathode lead, which is drawn out and exposed from an anode cylindrical structure, is joined onto the outside surface of the anode cylindrical structure on the input portion side, and a sealable waveguide is joined onto the outside surface of the anode cylindrical structure on the output portion side. Further, the anode cylindrical structure has a configuration in which a communication hole including a first opening that opens to an area surrounded by the shield casing and a second opening that opens to the interior of the waveguide is provided.

In the electron tube configured in this way, the interior of the waveguide and the interior of the shield casing can be communicated to each other. For example, in a case where the interior of the waveguide is filled with a pressurized dry air, where the interior of the waveguide is filled with a sulfur hexafluoride gas having a high insulation performance, or where a vacuum state is created inside the waveguide, in order to transmit high-power microwaves; the interior of the shield casing communicated via the communication hole is also filled with a pressurized dry air or a sulfur hexafluoride gas or is kept under the vacuum state, thus, a withstand voltage at the input portion can be improved, and as a result, it becomes possible to realize a higher power output of the electron tube.

### Embodiment 1

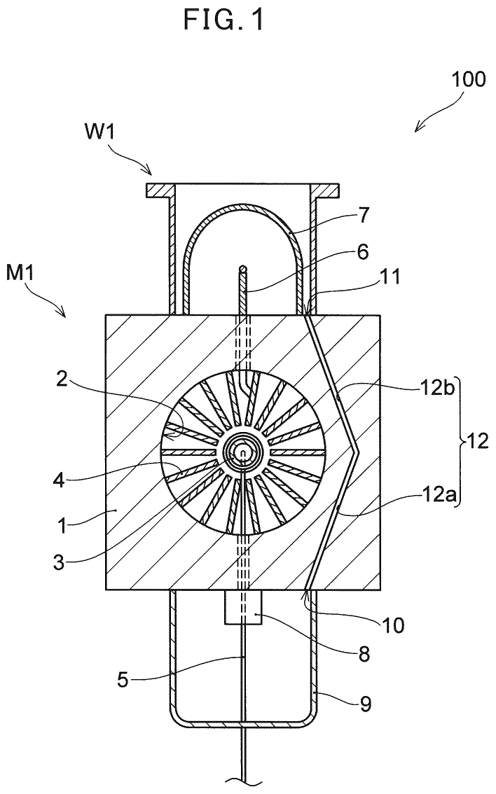

First, Embodiment 1 of the electron tube of the present invention is explained. FIG. 1 is a schematic cross-sectional view, perpendicular in a tube axis direction of an anode cylinder, for explaining Embodiment 1 of the electron tube of the present invention. As shown in FIG. 1, the electron tube 100 in the present embodiment has a configuration in which a waveguide W1 is joined to an output portion of a magnetron M1. In the magnetron M1, similarly to a typical magnetron, an anode cylinder 2 in a cylindrical shape is formed inside an anode cylindrical structure 1, and a plurality of anode pieces 4 are radially arranged. One of the ends of each anode piece 4 is joined to an inner wall of the anode cylinder 2, and an anode that has a ground potential is formed. A cathode 3 is arranged at the center of the anode pieces 4 that are radially arranged. The anode pieces 4 may be integrally formed with the anode cylinder 2 as long as a structure in which a cavity resonator is formed in a space surrounded by the anode pieces and the anode cylinder 2 is formed.

A negative voltage equivalent to an anode voltage is applied as an input voltage to the cathode 3 from cathode leads 5 that are drawn out to the input portion. Further, the cathode 3 is heated by a heater (not shown) and emits thermal electrons. The cathode 3 shown in FIG. 1 is supported at both ends thereof by the cathode leads 5 in a direction perpendicular to a central axis of the cathode 3, and two cathode leads 5 are drawn out to the input portion. The side surface of the anode cylindrical structure 1 from which the cathode leads 5 are drawn out becomes an “outside surface of the anode cylindrical structure on the input portion side.” A magnetic circuit (not shown) is arranged on both side surfaces of the anode cylindrical structure 1 in the tube axis direction of the anode cylinder 2, and a magnetic field is formed inside the anode cylinder 2 along an axial direction of the cathode 3 by this magnetic circuit. Electrons emitted from the cathode 3 that has a negative voltage with respect to the anode that has a ground potential are influenced by the electric field and the magnetic field to begin an orbital movement in an interaction space between the cathode 3 and the tips of the anode pieces 4 and are resonated in a cavity resonator formed between the anode pieces 4, and microwaves are excited. The microwaves are outputted to the waveguide W1 from an antenna 6 of the output portion. The side surface of the anode cylindrical structure 1 from which the antenna 6 covered by an antenna cap 7 protrudes and to which the waveguide W1 is joined becomes an “outside surface of the anode cylindrical structure on the output portion side.”

In the high-power electron tube 100, it is necessary to improve a withstand voltage between the cathode leads 5 of the magnetron M1 to which a high negative voltage is applied as an input voltage and the anode cylindrical structure 1 that has a ground potential. As shown in FIG. 1, the cathode leads 5 connected to the cathode 3 are fixed to the anode cylindrical structure 1 with an insulation member 8. Further, the anode cylindrical structure 1 is sealed by the insulation member 8, and the cathode leads 5 are exposed from a vacuum container including the anode cylinder 2. In the magnetron M1 having such a structure, electric discharge and the like easily occur between the cathode leads 5 exposed from the insulation member 8 and the anode cylindrical structure 1. Accordingly, in the electron tube 100 in the present embodiment, a shield casing 9 is joined in a sealable manner to the outside surface of the anode cylindrical structure 1 on the input portion side so as to surround a part of the cathode leads 5 exposed from the vacuum container. With such a configuration, the part of the cathode leads 5 and a part of the anode cylindrical structure 1, at which electric discharge and the like easily occur essentially, can be surrounded by the shield casing 9. Further, the anode cylindrical structure 1 is equipped with a communication hole 12 having a first opening 10 that opens to an area surrounded by the shield casing 9 and a second opening 11 that opens to the interior of the waveguide W1.

The electron tube 100 in the present embodiment shown in FIG. 1 has a configuration in which, the input portion to which the cathode leads 5 of the magnetron M1 are drawn out and the output portion in which the antenna 6 is arranged and from which microwaves are outputted to the outside are arranged in a direction perpendicular to the tube axis direction of the anode cylinder 2 so as to sandwich the anode cylinder 2 therebetween. Further, in the configuration, the antenna 6 covered by the antenna cap 7 is inserted into the waveguide from an end surface of a circular waveguide or an E-plane of a rectangular waveguide. Accordingly, the communication hole 12, which has the first opening 10 that opens to an area surrounded by the shield casing 9 on the outside surface of the anode cylindrical structure 1 on the input portion side and the second opening 11 that opens to the interior of the waveguide W1 on the outside surface of the anode cylindrical structure 1 on the output portion side, has a configuration in which a first hole portion 12a having the first opening 10 and a second hole portion 12b having the second opening 11 are directly joined to each other. With such a configuration, the communication hole 12 can be arranged without enlarging an area of the anode cylindrical structure 1 surrounded by the shield casing 9 and an area of the anode cylindrical structure 1 surrounded by the waveguide W1. Moreover, the communication hole 12 having such a configuration can be formed in a simple and easy way by forming the first hole portion 12a in a linear shape from the outside surface of the anode cylindrical structure 1 on the input portion side and further forming the second hole portion 12b in a linear shape from the outside surface of the anode cylindrical structure 1 on the output portion side.

The electron tube 100 in the present embodiment that can be used as a microwave oscillation source is used, for example, in a manner that the waveguide W1 that transmits microwaves is connected to the Linac system. In order to improve a power capacity of a waveguide that transmits high-power microwaves, for example, a pressurized dry air or sulfur hexafluoride gas having a high insulation performance is filled into a waveguide including the waveguide W1, or the inside of the waveguide is kept under a vacuum state. In this way of use, in the electron tube 100 of the present embodiment, the interior of the waveguide W1 and the interior of the shield casing 9 are communicated to each other via the communication hole 12, and the shield casing 9 is sealed on the outside surface of the anode cylindrical structure 1, so that the interior of the shield casing 9 is also filled with a pressurized dry air or sulfur hexafluoride gas having a high insulation performance or is kept under the vacuum state. As a result, electric discharge and the like between the cathode leads 5 exposed from the insulation member 8 and the anode cylindrical structure 1 is prevented, and it becomes possible to improve a withstand voltage of the input portion.

As an example, when a dry air is filled into the waveguide W1 and the shield casing 9 and a pressure is set to 2.5 kg/cm², it becomes possible to form an electron tube with an input voltage of 46V and an output voltage of 3 MW.

### Embodiment 2

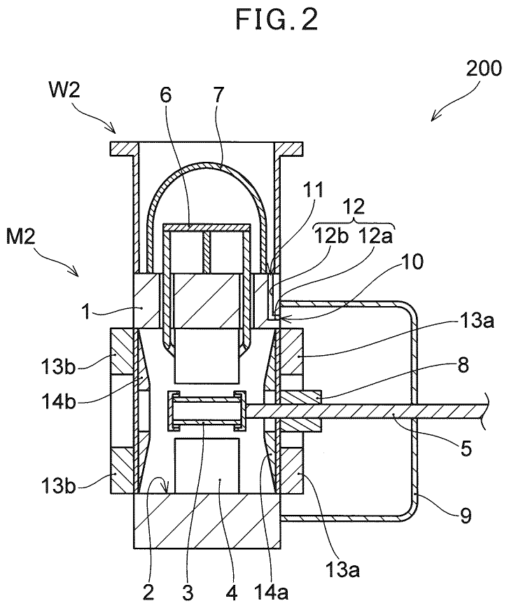

Next, Embodiment 2 of the electron tube of the present invention is explained. FIG. 2 is a schematic cross-sectional view, along a tube axis direction of an anode cylinder 2, for explaining Embodiment 2 of the electron tube of the present invention. As shown in FIG. 2, the electron tube 200 in the present embodiment has a configuration in which a waveguide W2 is joined to an output portion of a magnetron M2. Similarly to the magnetron M1 explained in the above-described Embodiment 1, in the magnetron M2, a cathode 3 and anode pieces 4 are arranged in the anode cylinder 2 formed inside an anode cylindrical structure 1 in a rectangular shape. Configurations of an input portion and the output portion of the magnetron M2 and a communication hole 12 are mainly explained in detail below.

The electron tube 200 of the present embodiment shown in FIG. 2 has a configuration in which the input portion to which a cathode lead 5 of the magnetron M2 is drawn out is arranged in the tube axis direction of the anode cylinder 2, and the output portion, in which an antenna 6 is arranged, that emits microwaves outside is arranged in a direction perpendicular to the tube axis direction of the anode cylinder 2. Further, in the configuration, the antenna 6 covered by an antenna cap 7 is inserted into the waveguide from an end surface of a circular waveguide or an E-plane of a rectangular waveguide.

On both side surfaces of the anode cylindrical structure 1 at both ends of the anode cylinder 2 in the tube axis direction, a pair of ring-shaped magnets 13a and 13b and a yoke (not shown) are arranged, which constitute a magnetic circuit. Magnetic forces of the magnets 13a and 13b of the magnetic circuit are applied, by pole pieces 14a and 14b, respectively, to an interaction space between the cathode 3 and the tip of the anode piece 4.

The cathode 3 shown in FIG. 2 has a configuration in which the cathode 3 is supported by the cathode lead 5 in a direction of a central axis of the cathode 3, and the cathode lead 5 is drawn out to the input portion. The side surface of the anode cylindrical structure 1 from which the cathode lead 5 is drawn out becomes an “outside surface of the anode cylindrical structure on the input portion side.” Further, a side surface of the anode cylindrical structure 1 from which the antenna 6 covered by the antenna cap 7 protrudes and to which the waveguide W2 is joined becomes an “outside surface of the anode cylindrical structure on the output portion side.”

As shown in FIG. 2, the cathode lead 5 connected to the cathode 3 is fixed to the anode cylindrical structure1 with an insulation member 8. Further, the anode cylindrical structure 1 is sealed by the insulation member 8, and the cathode lead 5 is exposed from a vacuum container including the anode cylinder 2. In order to prevent electric discharge and the like between the cathode lead 5 exposed from the insulation member 8 and the anode cylindrical structure 1, a shield casing 9 is joined in a sealable manner to the outside surface of the anode cylindrical structure 1 on the input portion side so as to surround a part of the cathode lead 5 exposed from the vacuum container, also in the electron tube 200 in the present embodiment. With such a configuration, the part of the cathode lead 5 and a part of the anode cylindrical structure 1, at which electric discharge and the like easily occur essentially, can be surrounded by the shield casing 9. Further, the anode cylindrical structure 1 is equipped with a communication hole 12 having a first opening 10 that opens to an area surrounded by the shield casing 9 and a second opening 11 that opens to the interior of the waveguide W2.

The electron tube 200 in the present embodiment shown in FIG. 2 has a configuration in which the input portion to which the cathode lead 5 of the magnetron M2 is drawn out is arranged along the tube axis direction of the anode cylinder 2. Further, the output portion on which the antenna 6 is arranged and from which microwaves are outputted to the outside is arranged in a direction perpendicular to the tube axis direction of the anode cylinder 2, and the antenna 6 covered by the antenna cap 7 is inserted into the waveguide from an end surface of a circular waveguide or an E-plane of a rectangular waveguide. Accordingly, the communication hole 12, which has the first opening 10 that opens to an area surrounded by the shield casing 9 on the outside surface of the anode cylindrical structure 1 on the input portion side and the second opening 11 that opens to the interior of the waveguide W2 on the outside surface of the anode cylindrical structure 1 on the output portion side, has a configuration in which a first hole portion 12a having the first opening 10 and a second hole portion 12b having the second opening 11 are directly joined to each other. The communication hole 12 having such a configuration can be formed in a simple and easy way by forming the first hole portion 12a in a linear shape from the outside surface of the anode cylindrical structure 1 on the input portion side and further forming the second hole portion 12b in a linear shape from the outside surface of the anode cylindrical structure 1 on the output portion side. In the present embodiment, it is possible to provide the communication hole 12 only with use of a relatively small area of the anode cylindrical structure 1. Therefore, other structures provided within the anode cylindrical structure 1, for example, such as a coolant water passage do not cause any problem in providing the communication hole 12.

Also in the electron tube 200 in the present embodiment that can be used as a microwave oscillation source, in order to improve a power capacity of a waveguide that transmits high-power microwaves, for example, a pressurized dry air or sulfur hexafluoride gas having a high insulation performance is filled into a waveguide including the waveguide W2, or the inside of the waveguide is kept under a vacuum state. In this way of use, in the electron tube 200 of the present embodiment, the interior of the waveguide W2 and the interior of the shield casing 9 are communicated to each other via the communication hole 12, and the shield casing 9 is sealed on the outside surface of the anode cylindrical structure 1, so that the interior of the shield casing 9 is also filled with a pressurized dry air or sulfur hexafluoride gas having a high insulation performance or is kept under the vacuum state. As a result, electric discharge and the like between the cathode lead 5 exposed from the insulation member 8 and the anode cylindrical structure 1 is prevented, and it becomes possible to improve a withstand voltage of the input portion. It should be noted that the magnet 13a is arranged inside the shield casing 9 in the present embodiment, but the arrangement does not affect improvement of a withstand voltage.

### Embodiment 3

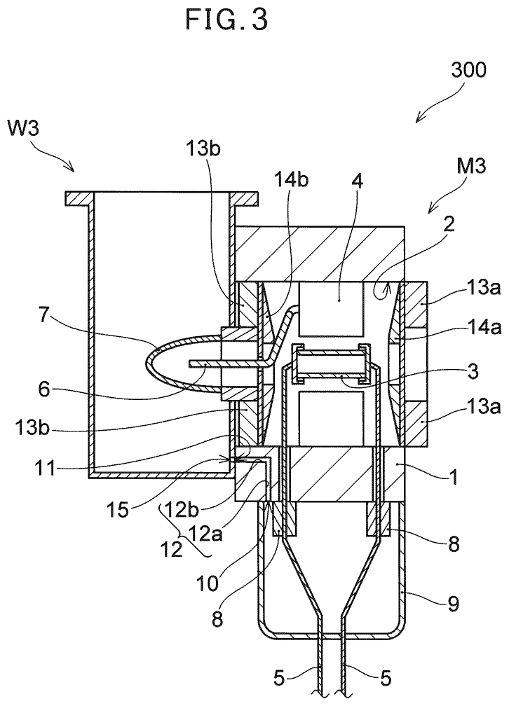

Next, Embodiment 3 of the electron tube of the present invention is explained. FIG. 3 is a schematic cross-sectional view, along a tube axis direction of an anode cylinder 2, for explaining Embodiment 3 of the electron tube of the present invention. As shown in FIG. 3, the electron tube 300 in the present embodiment has a configuration in which a waveguide W3 is joined to an output portion of a magnetron M3. Similarly to the magnetron M1 explained in the above-described Embodiment 1, in the magnetron M3, a cathode 3 and anode pieces 4 are arranged in the anode cylinder 2 formed inside an anode cylindrical structure 1 in a rectangular shape. Configurations of an input portion and the output portion of the magnetron M3 and a communication hole 12 are mainly explained in detail below.

The electron tube 300 of the present embodiment shown in FIG. 3 has a configuration in which the input portion to which cathode leads 5 of the magnetron M3 are drawn out is arranged in a direction perpendicular to the tube axis direction of the anode cylinder 2, and the output portion in which an antenna 6 is arranged and from which microwaves are emitted to the outside is arranged in the tube axis direction of the anode cylinder 2. Further, in the configuration, the antenna 6 covered by an antenna cap 7 is inserted into the waveguide from an E-plane of a rectangular waveguide.

On both side surfaces of the anode cylindrical structure 1 at both ends of the anode cylinder 2 in the tube axis direction, a pair of ring-shaped magnets 13a and 13b and a yoke (not shown) are arranged, which constitute a magnetic circuit. Magnetic forces of the magnets 13a and 13b of the magnetic circuit are applied, by pole pieces 14a and 14b, respectively, to an interaction space between the cathode 3 and the tip of the anode piece 4.

Similarly to the support structure of the cathode 3 explained in the above-described Embodiment 1, the cathode 3 shown in FIG. 3 has a configuration in which the cathode 3 is supported at both ends thereof by the cathode leads 5 in a direction perpendicular to a central axis of the cathode 3, and two cathode leads 5 are drawn out to the input portion. The side surface of the anode cylindrical structure 1 from which the cathode leads 5 are drawn out becomes an “outside surface of the anode cylindrical structure on the input portion side.” Further, a side surface of the anode cylindrical structure 1 from which the antenna 6 covered by the antenna cap 7 protrudes and to which the waveguide W3 is joined becomes an “outside surface of the anode cylindrical structure on the output portion side.”

As shown in FIG. 3, the cathode leads 5 connected to the cathode 3 are fixed to the anode cylindrical structure 1 with an insulation member 8. Further, the anode cylindrical structure 1 is sealed by the insulation member 8, and the cathode leads 5 are exposed from a vacuum container including the anode cylinder 2. In order to prevent electric discharge and the like between the cathode leads 5 exposed from the insulation member 8 and the anode cylindrical structure 1, a shield casing 9 is joined in a sealable manner to the outside surface of the anode cylindrical structure 1 on the input portion side so as to surround a part of the cathode leads 5 exposed from the vacuum container, also in the electron tube 300 in the present embodiment. With such a configuration, the part of the cathode leads 5 and a part of the anode cylindrical structure 1, at which electric discharge and the like easily occur essentially, can be surrounded by the shield casing 9. Further, the anode cylindrical structure 1 is equipped with a communication hole 12 having a first opening 10 that opens to an area surrounded by the shield casing 9 and a second opening 11 that opens to the interior of the waveguide W3. It should be noted that the second opening 11 is arranged inside a through hole 15 that is formed on an E-plane of the waveguide W3, thereby resulting in a configuration in which the second opening 11 opens to the interior of the waveguide W3.

The electron tube 300 in the present embodiment shown in FIG. 3 has a configuration in which the input portion to which the cathode leads 5 of the magnetron M3 are drawn out is arranged in a direction perpendicular to the tube axis direction of the anode cylinder 2. Further, in the configuration, an output portion in which the antenna 6 is arranged and from which microwaves are emitted to the outside is arranged along the tube axis direction of the anode cylinder 2, and the antenna 6 covered by the antenna cap 7 is inserted into the waveguide from an E-plane of a rectangular waveguide. Accordingly, the communication hole 12, which has the first opening 10 that opens to an area surrounded by the shield casing 9 on the outside surface of the anode cylindrical structure 1 on the input portion side and the second opening 11 that opens to the interior of the waveguide W3 via the through hole 15 formed on the waveguide W3 on the outside surface of the anode cylindrical structure 1 on the output portion side, has a configuration in which a first hole portion 12a having the first opening 10 and a second hole portion 12b having the second opening 11 are directly joined to each other. The communication hole 12 having such a configuration can be formed in a simple and easy way by forming the first hole portion 12a in a linear shape from the outside surface of the anode cylindrical structure 1 on the input portion side and further forming the second hole portion 12b in a linear shape from the outside surface of the anode cylindrical structure 1 on the output portion side. In the present embodiment, although it is necessary to form, on the waveguide W3, a through hole for inserting an output portion of the magnetron M3 and a through hole 15 for opening the second opening 11, it is possible to form these through holes in a simple and easy way through a typical production process of a waveguide. Further, it is possible to provide the communication hole 12 only with use of a relatively small area of the anode cylindrical structure 1. Therefore, other structures, such as a coolant water passage, provided within the anode cylindrical structure 1 do not cause any problem in providing the communication hole 12.

Also in the electron tube 300 in the present embodiment that can be used as a microwave oscillation source, in order to improve a power capacity of a waveguide that transmits high-power microwaves, for example, a pressurized dry air or a sulfur hexafluoride gas having a high insulation performance is filled into a waveguide including the waveguide W3, or the inside of the waveguide is kept under a vacuum state. In this way of use, in the electron tube 300 of the present embodiment, the interior of the waveguide W3 and the interior of the shield casing 9 are communicated to each other via the communication hole 12, and the shield casing 9 is sealed on the outside surface of the anode cylindrical structure 1, so that the interior of the shield casing 9 is also filled with a pressurized dry air or sulfur hexafluoride gas having a high insulation performance or is kept under the vacuum state. As a result, electric discharge and the like between the cathode leads 5 exposed from the insulation member 8 and the anode cylindrical structure 1 is prevented, and it becomes possible to improve a withstand voltage of the input portion.

### Embodiment 4

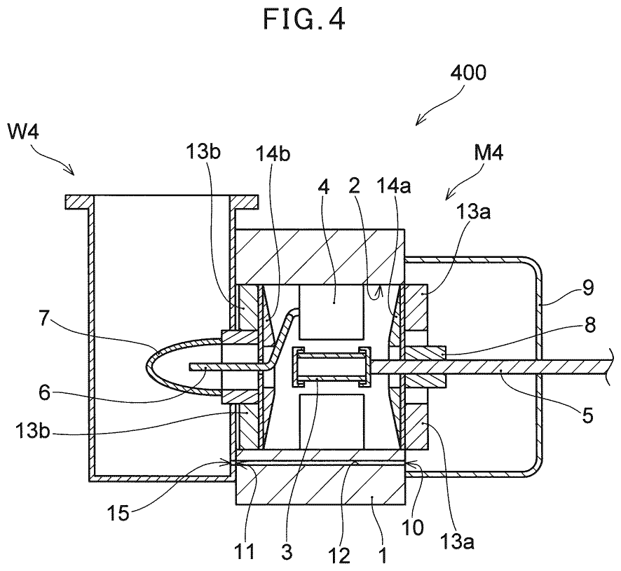

Next, Embodiment 4 of the electron tube of the present invention is explained. FIG. 4 is a schematic cross-sectional view, along the tube axis direction of an anode cylinder 2, for explaining Embodiment 4 of the electron tube of the present invention. As shown in FIG. 4, the electron tube 400 in the present embodiment has a configuration in which a waveguide W4 is joined to an output portion of a magnetron M4. Similarly to the magnetron M1 explained in the above-described Embodiment 1, in the magnetron M4, a cathode 3 and anode pieces 4 are arranged in the anode cylinder 2 formed inside an anode cylindrical structure 1 in a rectangular shape. Configurations of an input portion and the output portion of the magnetron M4 and a communication hole 12 are mainly explained in detail below.

The electron tube 400 of the present embodiment shown in FIG. 4 has a configuration in which the input portion to which a cathode lead 5 of the magnetron M4 is drawn out and the output portion in which an antenna 6 is arranged and from which microwaves are emitted to the outside are arranged in the tube axis direction of the anode cylinder 2 so as to sandwich the anode cylinder 2 therebetween. Further, in the configuration, the antenna 6 covered by an antenna cap 7 is inserted into the waveguide from an E-plane of a rectangular waveguide.

On both side surfaces of the anode cylindrical structure 1 at both ends of the anode cylinder 2 in the tube axis direction, a pair of ring-shaped magnets 13a and 13b and a yoke (not shown) are arranged, which constitute a magnetic circuit. Magnetic forces of the magnets 13a and 13b of the magnetic circuit are applied, by pole pieces 14a and 14b, respectively, to an interaction space between the cathode 3 and the tip of the anode piece 4.

Similarly to the support structure of the cathode 3 explained in the above-described Embodiment 2, the cathode 3 shown in FIG. 4 has a configuration in which the cathode 3 is supported by the cathode lead 5 in a direction of a central axis of the cathode 3, and the cathode lead 5 is drawn out to the input portion. The side surface of the anode cylindrical structure 1 from which the cathode lead 5 is drawn out becomes an “outside surface of the anode cylindrical structure on the input portion side.” Further, a side surface of the anode cylindrical structure 1 from which the antenna 6 covered by the antenna cap 7 protrudes and to which the waveguide W4 is joined becomes an “outside surface of the anode cylindrical structure on the output portion side.”

As shown in FIG. 4, the cathode lead 5 connected to the cathode 3 is fixed to the anode cylindrical structure 1 with an insulation member 8. Further, the anode cylindrical structure 1 is sealed by the insulation member 8, and the cathode lead 5 is exposed from a vacuum container including the anode cylinder 2. In order to prevent electric discharge and the like between the cathode lead 5 exposed from the insulation member 8 and the anode cylindrical structure 1, a shield casing 9 is joined in a sealable manner to the outside surface of the anode cylindrical structure 1 on the input portion side so as to surround a part of the cathode lead 5 exposed from the vacuum container, also in the electron tube 400 in the present embodiment. With such a configuration, the part of the cathode lead 5 and a part of the anode cylindrical structure 1, at which electric discharge and the like easily occur essentially, can be surrounded by the shield casing 9. Further, the anode cylindrical structure 1 is equipped with a communication hole 12 having a first opening 10 that opens to an area surrounded by the shield casing 9 and a second opening 11 that opens to the interior of the waveguide W4. It should be noted that the second opening 11 is arranged inside a through hole 15 that is formed on an E-plane of the waveguide W4, thereby resulting in a configuration in which the second opening 11 opens to the interior of the waveguide W4.

The electron tube 400 in the present embodiment shown in FIG. 4 has a configuration in which the input portion of the magnetron M4 to which the cathode lead 5 is drawn out and the output portion in which the antenna 6 is arranged and from which microwaves are emitted to the outside are arranged so as to sandwich the anode cylinder 2 therebetween in the tube axis direction of the anode cylinder 2. Further, in the configuration, the antenna 6 covered by the antenna cap 7 is inserted into the waveguide from an E-plane of a rectangular waveguide. Accordingly, the electron tube is configured to be equipped with the communication hole 12 having the first opening 10 that opens to an area surrounded by the shield casing 9 on the outside surface of the anode cylindrical structure 1 on the input portion side and the second opening 11 that opens to the interior of the waveguide W4 via the through hole 15 formed on the waveguide W4 on the outside surface of the anode cylindrical structure 1 on the output portion side. The communication hole 12 having such a configuration can be formed in a simple and easy way by forming a linear-shaped through hole through one-time process from the outside surface of the anode cylindrical structure 1 on the input portion side or the output portion side, which is good for workability. Further, a location at which the through hole is formed can be easily selected. In the present embodiment, although it is necessary to form, on the waveguide W4, a through hole for inserting an output portion of the magnetron M4 and a through hole 15 for opening the second opening 11, it is possible to form these through holes in a simple and easy way through a typical production process of a waveguide. Further, the communication hole 12 can be formed only with use of a quite small area in the anode cylindrical structure 1. Therefore, other structures such as a coolant water passage do not cause any problem.

Also in the electron tube 400 in the present embodiment that can be used as a microwave oscillation source, in order to improve a power capacity of a waveguide that transmits high-power microwaves, for example, a pressurized dry air or sulfur hexafluoride gas having a high insulation performance is filled into a waveguide including the waveguide W4, or the inside of the waveguide is kept under a vacuum state. In this way of use, in the electron tube 400 of the present embodiment, the interior of the waveguide W4 and the interior of the shield casing 9 are communicated to each other via the communication hole 12, and the shield casing 9 is sealed on the outside surface of the anode cylindrical structure 1, so that the interior of the shield casing 9 is also filled with a pressurized dry air or sulfur hexafluoride gas having a high insulation performance or is kept under the vacuum state. As a result, electric discharge and the like between the cathode lead 5 exposed from the insulation member 8 and the anode cylindrical structure 1 is prevented, and it becomes possible to improve a withstand voltage of the input portion. It should be noted that the magnet 13a is arranged inside the shield casing 9 in the present embodiment, but the arrangement does not affect improvement of a withstand voltage.

### Embodiment 5

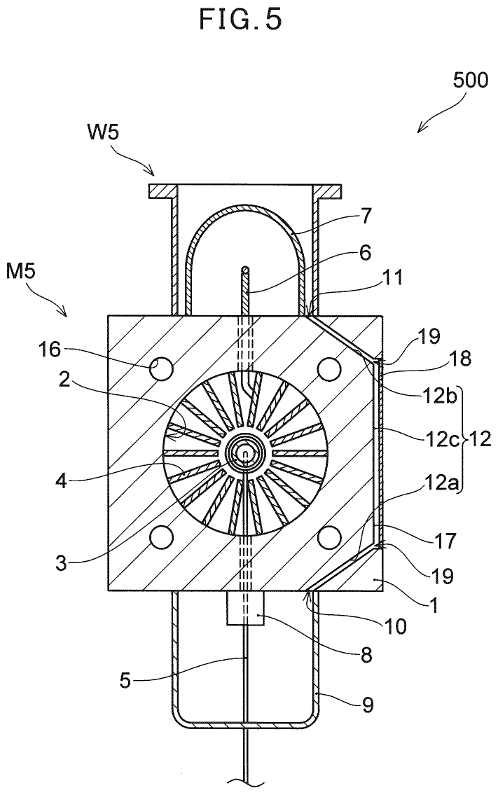

Next, the electron tube of the present invention in Embodiment 5 is described. FIG. 5 is a schematic cross-sectional view, perpendicular to a tube axis direction of an anode cylinder 2, for explaining Embodiment 5 of the electron tube of the present invention. As shown in FIG. 5, the electron tube 500 in the present embodiment has a configuration in which a waveguide W5 is joined to an output portion of a magnetron M5. Similarly to the magnetron M1 explained in the above-described Embodiment 1, in the magnetron M5, a cathode 3 and anode pieces 4 are arranged in the anode cylinder 2 formed inside the anode cylindrical structure 1 in a rectangular shape. Further, a shield casing 9 is joined in a sealable manner to the outside surface of the anode cylindrical structure 1 on the input portion side so as to surround a part of cathode leads 5 exposed from a vacuum container. Further, in the present embodiment, a coolant water passage 16 that passes a coolant water through an anode cylindrical structure 1 is arranged along the tube axis direction of the anode cylinder 2. Configurations of an input portion and the output portion of the magnetron M5 and a communication hole 12 are mainly explained in detail below.

The electron tube 500 in the present embodiment shown in FIG. 5 has a configuration in which the input portion of the magnetron M5 to which the cathode leads 5 are drawn out and the output portion in which an antenna 6 is arranged and from which microwaves are emitted to the outside are arranged in a direction perpendicular to the tube axis direction of the anode cylinder 2 so as to sandwich the anode cylinder 2 therebetween. Further, in the configuration, the antenna 6 covered by the antenna cap 7 is inserted into the waveguide from an end surface of a circular waveguide or an E-plane of a rectangular waveguide. In the present embodiment, the coolant water passage 16 is arranged in the anode cylindrical structure 1, and therefore, the communication hole 12, having a configuration in which a first hole portion 12a and a second hole portion 12b are directly connected to each other, as explained in FIG. 1 cannot be formed.

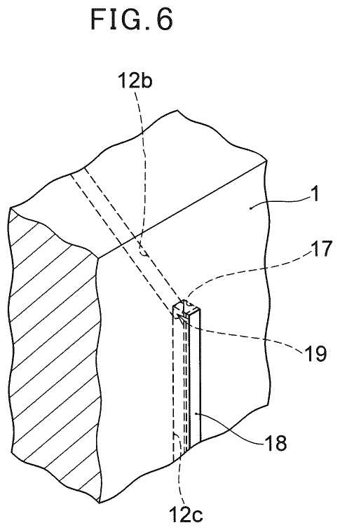

Accordingly, the communication hole 12 having a first opening 10 that opens to an area surrounded by the shield casing 9 in the outside surface of the anode cylindrical structure 1 on the input portion side and a second opening 11 that opens to the waveguide W5 in the outside surface of the anode cylindrical structure 1 on the output portion side has a configuration in which the first hole portion 12a having the first opening 10 and the second hole portion 12b having the second opening 11 are joined to each other via a third hole portion 12c. FIG. 6 is a partially enlarged view of a joint portion between the third hole portion 12c and the second hole portion 12b that constitute the communication hole 12 that is formed in the anode cylindrical structure 1. As shown in FIG. 5 and FIG. 6, a recessed portion 17 extending in a direction perpendicular to the tube axis direction of the anode cylinder 2 is formed on the outside surface of the anode cylindrical structure 1, and the third hole portion 12c is configured by covering an opening of the recessed portion 17 by a lid portion 18. A recessed portion-inside opening 19 is opened in the recessed portion 17. A hole having the recessed portion-inside opening 19 and the second opening 11 becomes the second hole portion 12b. Further, another recessed portion-inside opening 19 is formed in the recessed portion 17, though it is not shown in FIG. 6, and a hole portion having this recessed portion-inside opening 19 and the first opening 10 becomes the first hole portion 12a. The communication hole 12 configured by the first to third hole portions 12a-12c can be formed in a simple and easy way by forming the recessed portion 17 on the outside surface of the anode cylindrical structure 1, forming the first hole portion 12a in a linear shape so as to reach the recessed portion 17 from the outside surface of the anode cylindrical structure 1 on the input portion side and so as to form the recessed portion-inside opening 19, further forming the second hole portion 12b in a linear shape so as to reach the recessed portion 17 from the outside surface of the anode cylindrical structure 1 on the output portion side and so as to form the recessed portion-inside opening 19, and then covering the opening of the recessed portion 17 by the lid portion 18. The lid portion 18 may be formed before or after the formation of the first hole portion 12a, etc.

Also in the electron tube 500 in the present embodiment that can be used as a microwave oscillation source, in order to improve a power capacity of a waveguide that transmits high-power microwaves, for example, a pressurized dry air or a sulfur hexafluoride gas having a high insulation performance is filled into a waveguide including the waveguide W5 or the inside of the waveguide is kept under a vacuum state. In this way of use, in the electron tube 500 of the present embodiment, the interior of the waveguide W5 and the interior of the shield casing 9 are communicated to each other via the communication hole 12, and the shield casing 9 is sealed to the anode cylindrical structure 1, so that the interior of the shield casing 9 is also filled with a pressurized dry air or sulfur hexafluoride gas having a high insulation performance or is kept under the vacuum state. As a result, electric discharge and the like between the cathode leads 5 exposed from the insulation member 8 and the anode cylindrical structure 1 is prevented, and it becomes possible to improve a withstand voltage of the input portion. It should be noted that while the present embodiment is configured in a manner that the third hole portion 12c is covered by the lid portion 18, the joint between this lid portion 18 and the anode cylindrical structure 1 is configured to have a joint strength capable of sealing at the pressure of air or gas filled in the shield casing 9 and in a waveguide including the waveguide W5 or at a state being kept under the vacuum state.

### Embodiment 6

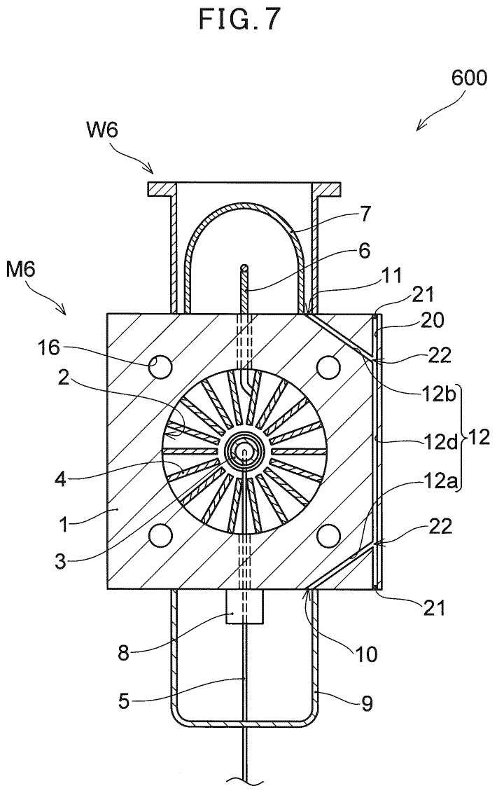

Next, the electron tube of the present invention in Embodiment 6 is described. FIG. 7 is a schematic cross-sectional view, perpendicular to a tube axis direction of an anode cylinder, for explaining Embodiment 6 of the electron tube of the present invention. As shown in FIG. 6, the electron tube 600 in the present embodiment has a configuration in which a waveguide W6 is joined to an output portion of a magnetron M6. Similarly to the magnetron M1 explained in the above-described Embodiment 1, in the magnetron M6 shown in FIG. 7, a cathode 3 and anode pieces 4 are arranged in the anode cylinder 2 formed inside an anode cylindrical structure 1 in a rectangular shape. Further, a shield casing 9 is joined in a sealable manner to the outside surface of the anode cylindrical structure 1 on the input portion side so as to surround a part of cathode leads 5 exposed from an interior of a vacuum container. Further, similarly to the above-described Embodiment 5, a coolant water passage 16 that passes a coolant water through the anode cylindrical structure 1 is arranged along the tube axis direction of the anode cylinder 2. Configurations of an input portion and the output portion of the magnetron M6 and a communication hole 12 are mainly explained in detail below.

The electron tube 600 in the present embodiment shown in FIG. 7 has a configuration in which the input portion to which the cathode leads 5 are drawn out and the output portion in which an antenna 6 is arranged and from which microwaves are emitted to the outside of the magnetron M6 are arranged in a direction perpendicular to the tube axis direction of the anode cylinder 2 so as to sandwich the anode cylinder 2 therebetween. Further, in the configuration, the antenna 6 covered by the antenna cap 7 is inserted into the waveguide from an end surface of a circular waveguide or an E-pane of a rectangular waveguide. Also in the present embodiment, the coolant water passage 16 is arranged in the anode cylindrical structure 1, and therefore, the communication hole 12, having a configuration in which a first hole portion 12a and a second hole portion 12b are directly connected to each other, as explained in FIG. 1 cannot be formed.

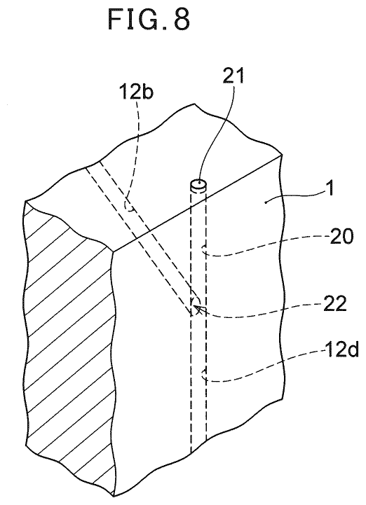

Accordingly, the communication hole 12 having a first opening 10 that opens to an area surrounded by the shield casing 9 in the outside surface of the anode cylindrical structure 1 on the input portion side and the second opening 11 that opens to the waveguide W6 in the outside surface of the anode cylindrical structure 1 on the output portion side has a configuration in which the first hole portion 12a having the first opening 10 and the second hole portion 12b having the second opening 11 are joined to each other via a fourth hole portion 12d. FIG. 8 is a partially enlarged view of a joint portion between the fourth hole portion 12d and the second hole portion 12b that constitute the communication hole 12 that is formed in the anode cylindrical structure 1. As shown in FIG. 7 and FIG. 8, a through hole 20 extending perpendicular in the tube axis direction of the anode cylinder 2 is formed in the vicinity of the surface of the anode cylindrical structure 1, and the fourth hole portion 12d is configured by sealing both ends of the through hole 20 by a lid portion 21. A through hole-inside opening 22 is opened in the through hole 20. A hole portion having the through hole-inside opening 22 and the second opening 11 becomes the second hole portion 12b. Further, another through hole-inside opening 22 is formed in the through hole 20, though it is not shown in FIG. 8, and a hole portion having this through hole-inside opening 22 and the first opening 10 becomes the first hole portion 12a. The communication hole 12 configured by the first hole portion 12a, the second hole portion 12b, and the fourth hole portion 12d can be formed in a simple and easy way by forming the through hole 20 in the vicinity of the surface of the anode cylindrical structure 1, forming the first hole portion 12a in a linear shape so as to reach the through hole 20 from the outside surface of the anode cylindrical structure 1 on the input portion side and so as to form the through hole-inside opening 22, further forming the second hole portion 12b in a linear shape so as to reach the through hole 20 from the outside surface of the anode cylindrical structure 1 on the output portion side and so as to form the through hole-inside opening 22, and then sealing the openings at both ends of the through hole 20 by the lid portion 21. The lid portion 21 may be formed before or after the formation of the first hole portion 12a and the like.

Also in the electron tube 600 in the present embodiment that can be used as a microwave oscillation source, in order to improve a power capacity of a waveguide that transmits high-power microwaves, for example, the inside of a waveguide including the waveguide W6 is filled with a pressurized dry air or a sulfur hexafluoride gas having a high insulation performance or the inside of the waveguide is kept under a vacuum state. In this way of use, in the electron tube 600 of the present embodiment, the interior of the waveguide W6 and the interior of the shield casing 9 are communicated to each other via the communication hole 12, and the shield casing 9 is sealed to the anode cylindrical structure 1, so that the interior of the shield casing 9 is also filled with a pressurized dry air or sulfur hexafluoride gas having a high insulation performance or is kept under the vacuum state. As a result, electric discharge and the like between the cathode leads 5 exposed from the insulation member 8 and the anode cylindrical structure 1 is prevented, and it becomes possible to improve a withstand voltage of the input portion. It should be noted that while the present embodiment is configured in a manner that the fourth hole portion 12d is sealed by the lid portion 21, the joint between this lid portion 21 and the anode cylindrical structure 1 is configured to have a joint strength capable of sealing at the pressure of air or gas filled in the shield casing 9 and in a waveguide including the waveguide W6 or at a state being kept under the vacuum state.

As described above, the electron tubes 100-600 in the present embodiments do not use any member that degrades due to a high temperature, and thus there is no problem even if the anode cylindrical structure 1, the shield casing 9, and the like have a high temperature. Further, even if the gas inside the shield casing 9 is thermally expanded, there will not be a case where only the pressure inside the shield casing 9 becomes large since the interior of the shield casing 9 is communicated with the waveguide W2 and the like having a relatively large volume via the communication hole 12, and also there will not be a case where the joint strength between the shield casing 9 and the anode cylindrical structure 1, or the joint strength between the lid portion 21 and the anode cylindrical structure 1 or between the lid portion 21 and the anode cylindrical structure 1 is degraded.

Accordingly, in the electron tubes 100-600 in the present embodiments, electric discharge and the like inside the shield casing 9 is prevented, and a high input voltage can be applied, so that a higher power-output of the electron tube can be attained, without a need of a complex configuration. Further, they can also be used in highlands where electric discharge easily occurs.

Although the embodiments of the electron tube in the present invention are described above, it is needless to say that the present invention is not limited to the above-described embodiments. For example, the joint structure between the magnetron and the waveguide, the arrangement of the input portion and output portion of the magnetron, and the like can be appropriately modified. The communication hole 12 can be appropriately modified as long as it is configured to have the first opening 10 that opens to at least an area surrounded by the shield casing 9 and the second opening 11 that opens to the waveguide. The anode cylindrical structure 1 can be configurated to include in a part thereof a member that does not constitute an anode such as a spacer, for example. Further, the shape of the anode cylindrical structure 1 is not limited to a rectangular shape as long as it can be joined to the shield casing 9 and the waveguide in a sealed manner. The shapes of the communication hole 12 and the through holes 15 and 20 may be any shape as long as they can pass air or gas. The shape of the shield casing 9 can also be appropriately modified.

### Summary

(1) One embodiment of an electron tube of the present invention is an electron tube comprising: a cathode that emits thermoelectrons; an anode comprising a plurality of anode pieces arranged, so as to surround the cathode, in an anode cylinder inside an anode cylindrical structure, in which a cavity resonator is formed between the anode pieces; an input portion to which a cathode lead to apply an input voltage to the cathode is drawn out; an output portion that emits microwaves excited in the cavity resonator outside; and a waveguide that transmits the microwaves emitted from the output portion, and having a configuration in which: a sealable shield casing that surrounds a part of the cathode lead is joined onto the outside surface of the anode cylindrical structure on the input portion side; the waveguide that is sealable is joined onto the outside surface of the anode cylindrical structure on the output portion side; and the anode cylindrical structure has a communication hole including a first opening that opens to an area surrounded by the shield casing and a second opening that opens to an interior of the waveguide.

According to the electron tube in the embodiment of the above-described (1), because of a configuration having the communication hole that has openings respectively in an area that is surrounded by the shield casing covering a part of the cathode lead for applying an input voltage to the cathode and in the waveguide that transmits microwaves emitted from the output portion, the interior of the waveguide that transmits high-power microwaves and the interior of the shield casing are communicated to each other, and a withstand voltage of the input portion is improved, so that a high-power electron tube can be provided.
(2) According to another embodiment, in the electron tube of the above-described (1), the second opening is arranged inside a through hole formed on a wall surface of the waveguide.
(3) According to yet another embodiment, in the electron tube of the above-described (1) or (2), the communication hole is configured in a manner that a first hole portion having the first opening and a second hole portion having the second opening are directly joined to each other.
(4) According to yet another embodiment, in the electron tube of the above-described (1) or (2), the anode cylindrical structure comprises a third hole portion configured by a recessed portion that is formed in the anode cylindrical structure and a lid portion that covers an opening of the recessed portion, and the communication hole is configured in a manner that a first hole portion having the first opening and a second hole portion having the second opening are joined to each other via the third hole portion.
(5) According to yet another embodiment, in the electron tube of the above-described (1) or (2), the anode cylindrical structure includes a fourth hole portion configured by a through hole penetrating through the anode cylindrical structure and a lid portion covering an opening of the through hole, and the communication hole is configured in a manner that a first hole portion having the first opening and a second hole portion having the second opening are joined to each other via the fourth hole portion.
(6) According to yet another embodiment, in the electron tube of the above-described (1) or (2), the waveguide and the shield casing communicating via the communication hole are sealed, and the interior of the waveguide and an interior of the shield casing have an equal pressure and/or atmosphere to each other.

### REFERENCE SIGNS LIST

100-600 Electron tube
M1-M6 Magnetron
W1-W6 Waveguide
1 Anode cylindrical structure
2 Anode cylinder
3 Cathode
4 Anode piece
5 Cathode lead
6 Antenna
7 Antenna cap
8 Insulation member
9 Shield casing
10 First opening
11 Second opening
12 Communication hole
12a-12d First to fourth hole portion
13a, 13b Magnet
14a, 14b Pole piece
15, 20 Through hole
16 Coolant water passage
17 Recessed portion
18,21 Lid portion
19 Recessed portion-inside opening
22 Through hole-inside opening

1. An electron tube comprising:
a cathode that emits thermoelectrons;
an anode comprising a plurality of anode pieces arranged, so as to surround the cathode, in an anode cylinder inside an anode cylindrical structure, wherein a cavity resonator is formed between the anode pieces;
an input portion to which a cathode lead to apply an input voltage to the cathode is drawn out;
an output portion that emits microwaves excited in the cavity resonator outside; and
a waveguide that transmits the microwaves emitted from the output portion,
wherein a sealable shield casing that surrounds a part of the cathode lead is joined onto the outside surface of the anode cylindrical structure on the input portion side,
wherein the waveguide that is sealable is joined onto the outside surface of the anode cylindrical structure on the output portion side, and
wherein the anode cylindrical structure has a communication hole comprising a first opening that opens to an area surrounded by the shield casing and a second opening that opens to an interior of the waveguide.

2. The electron tube of claim 1, wherein the second opening is arranged inside a through hole formed on a wall surface of the waveguide.

3. The electron tube of claim 1, wherein the communication hole is configured in a manner that a first hole portion having the first opening and a second hole potion having the second opening are directly joined to each other.

4. The electron tube of claim 1,
wherein the anode cylindrical structure comprises a third hole portion configured by a recessed portion that is formed in the anode cylindrical structure and a lid portion that covers an opening of the recessed portion, and
wherein the communication hole is configured in a manner that a first hole portion having the first opening and a second hole portion having the second opening are joined to each other via the third hole portion.

5. The electron tube of claim 1,
wherein the anode cylindrical structure comprises a fourth hole portion configured by a through hole penetrating through the anode cylindrical structure and a lid portion covering an opening of the through hole, and
wherein the communication hole is configured in a manner that a first hole portion having the first opening and a second hole portion having the second opening are joined to each other via the fourth hole portion.

6. The electron tube of claim 1,
wherein the waveguide and the shield casing communicating via the communication hole are sealed, and
wherein the interior of the waveguide and an interior of the shield casing have an equal pressure and/or atmosphere to each other.

7. The electron tube of claim 2, wherein the communication hole is configured in a manner that a first hole portion having the first opening and a second hole potion having the second opening are directly joined to each other.

8. The electron tube of claim 2,
wherein the anode cylindrical structure comprises a third hole portion configured by a recessed portion that is formed in the anode cylindrical structure and a lid portion that covers an opening of the recessed portion, and
wherein the communication hole is configured in a manner that a first hole portion having the first opening and a second hole portion having the second opening are joined to each other via the third hole portion.

9. The electron tube of claim 2,
wherein the anode cylindrical structure comprises a fourth hole portion configured by a through hole penetrating through the anode cylindrical structure and a lid portion covering an opening of the through hole, and
wherein the communication hole is configured in a manner that a first hole portion having the first opening and a second hole portion having the second opening are joined to each other via the fourth hole portion.

10. The electron tube of claim 2,
wherein the waveguide and the shield casing communicating via the communication hole are sealed, and
wherein the interior of the waveguide and an interior of the shield casing have an equal pressure and/or atmosphere to each other.
